(19) United States
(12) Patent Application Publication
(10) Pub. No.: US 2008/0109603 A1
(43) Pub. Date: May 8, 2008

(54) MEMORY CARD WITH SEPARABLE MEMORY PACKAGE AND ADAPTOR AND METHOD OF USING THE SAME

(75) Inventor: Gwang-man LIM, Yangcheon-gu (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Gyeonggi-do (KR)

(21) Appl. No.: 11/764,930

(22) Filed: Jun. 19, 2007

(30) Foreign Application Priority Data
Nov. 2, 2006 (KR) 10-2006-0107942

(51) Int. Cl. G06F 13/00; H01R 12/14

(52) U.S. Cl. 711/115; 439/260; 439/65; 710/13

(57) ABSTRACT

A memory card is disclosed and includes an adaptor comprising a card controller controlling operations of the memory card, and a memory package capable of being electrically/mechanically connected to and separated from the adaptor via a connection structure. A method of using a memory card is also disclosed and includes connecting the adaptor to the memory package via the connection structure, identifying a memory card type in relation to the functional nature of the card controller upon connection of the memory package with the adaptor, and communicating data between the card controller and memory package.

### CROSS-REFERENCE TO RELATED PATENT APPLICATIONS

This application claims the benefit of Korean Patent Application No. 10-2006-0107942, filed on Nov. 2, 2006, the subject matter of which is hereby incorporated by reference.

### BACKGROUND OF THE INVENTION

1. Field of the Invention

The present invention relates to a memory card and a method of using a memory card. More particularly, the invention relates to a memory card having an adapter capable of having a memory package inserted therein and a method of using the memory card.

2. Description of the Related Art

Memory cards for storing and reproducing data in digital appliances such as MP3 players and digital cameras are commonly referred to as smart media cards. Smart media cards, and memory cards of all other types, are small, light-weight devices capable of storing an impressive quantity of data. Contemporary memory cards are implemented with non-volatile memory devices, such as flash memory, and associated control circuitry.

The performance demands placed on memory cards have increased of late due to the expanding capabilities of digital mobile devices and their incorporation into new applications. In response, the functionality of memory cards has expanded to meet these demands. Figure (FIG.) 1 is a schematic view of a conventional memory card 10. Referring to FIG. 1, the conventional memory card 10 has a wholly integral structure including a main body 12 on which a card controller (Card CTL) 20 and associated memory chip (M) 30 are mounted.

However, referring to FIG. 2, when a plurality of “n” conventional memory cards are used (e.g., memory chips M1, . . . , Mn), typically a corresponding plurality of “n” card controllers are also required. That is, in a case where a plurality of memory cards is associated with a digital appliance, a large number of card controllers are provided—one card controller per memory card. This arrangement is not only inefficient but also wasteful because in a case where a certain memory card is not used amongst the plurality of memory cards, its card controller and its memory chip resources cannot be used.

### SUMMARY OF THE INVENTION

Embodiments of the invention provide a memory card capable of independently utilizing alternate card controller and memory chip resources. Embodiments of the invention also provide a method of using memory card(s).

In one embodiment, the invention provides a memory card comprising; an adaptor comprising a card controller controlling operations of the memory card, and a memory package capable of being electrically/mechanically connected to and separated from the adaptor via a connection structure.

The connection structure may be a full insertion recess or a partial insertion recess disposed on the adaptor, or at least one pair of connection contacts disposed respectively on the adaptor and the memory package.

In another embodiment, the invention provides a method of using a memory card, the method comprising; electrically and mechanically connecting an adaptor including a card controller to a memory package via a connection structure, identifying a memory card type in relation to the functional nature of the card controller upon connection of the memory package with the adaptor, and communicating data between the card controller and memory package.

### BRIEF DESCRIPTION OF THE DRAWINGS

Embodiments of the invention will be described with reference to the attached drawings in which:

FIG. 1 is a schematic view of a conventional memory card;

FIG. 2 is a schematic view of a plurality of conventional memory cards;

FIG. 3 is a schematic view of a memory card according to an embodiment of the present invention;

FIGS. 4 and 5 are schematic views of memory cards according to other embodiments of the present invention; and

FIGS. 6 through 8 are diagrams illustrating a method of using the memory card according to an embodiment of the present invention.

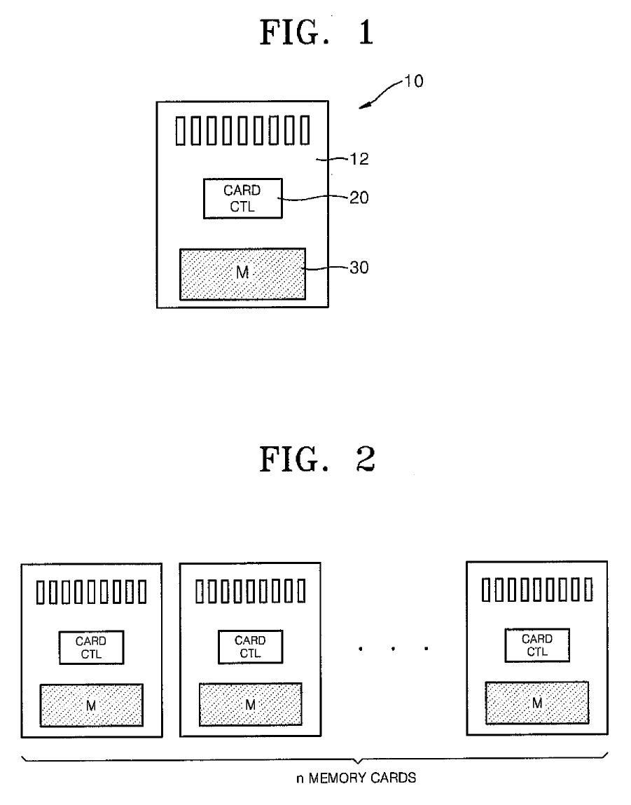

### DESCRIPTION OF EMBODIMENTS

Embodiments of the invention will now be described with reference to the accompanying drawings. The invention may, however, be embodied in many different forms and should not be construed as being limited to only the illustrated embodiments. Rather, these embodiments are presented as teaching examples. Throughout the drawings and written description, like reference numerals denote like or similar elements.

In one aspect, embodiments of the invention provide a memory card having a structure which allows separation of a card controller from a memory chip. When separated, the controller and memory chip may be independently operated. Several exemplary structures for a memory card having separable components and related methods of use will be described with reference selected embodiments of the invention. However, the scope of the invention is not limited to only the disclosed types of packages and adapters. Other shapes and/or configurations may be used.

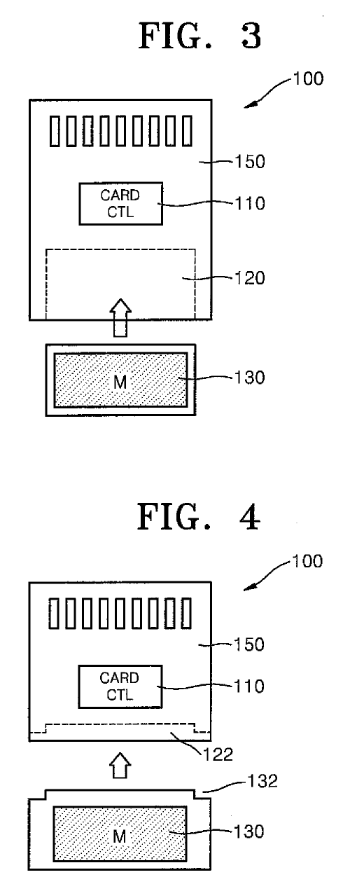

FIG. 3 is a schematic view of a memory card 100 according to an embodiment of the invention.

Referring to FIG. 3, memory card 100 includes an adaptor 150 including having a card controller (CTL) 110, and a memory package 130 capable of being operatively inserted into adaptor 150. In the illustrated example of FIG. 3, the overall form of adaptor 150 has the same basic shape as a conventional memory card. However, this need not be the case. Memory package 130 includes a memory chip “M” of competent form and function, such as a conventional flash memory.

The card controller 110 may be conventional in its design and operation and may be variously embodied. In general, however, card controller 110 will control the operations (e.g., data read/write operations) of memory card 100. Indeed, it is expected that functionality and structure of card controller 110 will follow its associated with one or more digital devices or its use within a particular application. For example, card controller 110 may be implemented as a single IC logic device or a chip set.

In the illustrated embodiment of FIG. 3, adaptor 150 has a structure that allows memory package 130 to be substantially inserted (or coupled) within its physical form, i.e., a full insertion recess 120. The shape of full insertion recess 120 will be determined by the shape of memory package 130, but as shown in the illustrated example, it provides for the substantial or complete insertion of memory package 130 into adapted 150.

Adaptor 150, and more particularly first insertion recess 120, includes one or more electrical contacts capable of forming electrical connection(s) between an inserted memory package 130 and card controller 110.

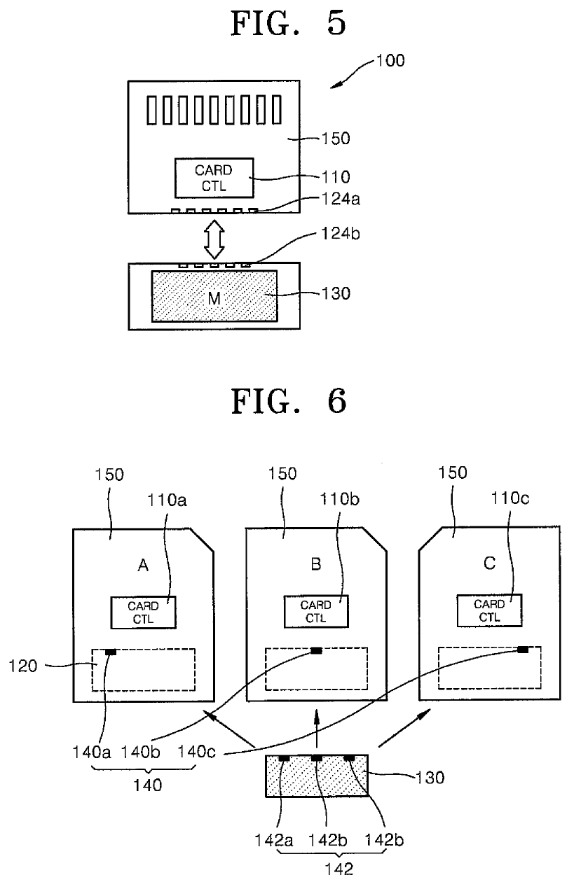

FIGS. 4 and 5 illustrate alternate embodiments for memory card 100. In these embodiments, the physical forms of adaptor 150 and memory package 130 are varied from the example shown in FIG. 3. For example, as shown in FIG. 4, memory package 130 may be partially inserted within the physical form of adaptor 150. Thus, adapted 150 includes a partial insertion recess 122 adapted to receive a connection protrusion 132 from memory package 130. Connection protrusion 132 is inserted into partial insertion recess 122 to connection memory package 130 with card controller 110.

Referring to FIG. 5, adaptor 150 includes one or more first connection contacts 124a designed to mate with second connection contacts 124b on memory package 130. Thus, adaptor 150 need not contain a physical recess capable of receiving (wholly or partially) memory package 130. Rather, paired connection contacts on memory package 130 and adaptor 150 may be used to mechanically and electrically connect these components. Such connection contacts may take one of many different forms.

Each one of the foregoing “connection structures” allow memory package 130 to be connected to and separated from adaptor 150. However, in the illustrated examples of FIGS. 4 and 5 the connected memory package 130 remains significantly exposed outside of the adaptor 150. In contrast, the memory card 130 inserted into the full insertion recess of the illustrated example of FIG. 3 is largely if not entirely captured within the structure of adaptor 150.

However, in each of the foregoing embodiments, a memory card 100 provides an adaptor 150 including a card controller 110 that may be separated from a compatible memory package 130. This capability allows a more flexible and efficient use of resources in the context of a memory card 100. FIGS. 6 through 8 are diagrams illustrating some exemplary capabilities and/or use methods for selected embodiments of the invention.

Referring to FIG. 6, different memory cards A, B, and C respectively include a different type of card controller 110a, 110b, and 110c. The card controllers may differ in manufacture, design, operation, or corresponding protocol definitions. However, a common memory package 130 may be used between each of these different card controllers.

In the illustrated example, memory card 130 includes a plurality of recognition patterns 142a, 142b, and 142c respectively associated with corresponding plurality of designation patterns 140a, 140b, and 140c found on memory cards A, B, and C. For example, physically positioned recess/protrusion pairs may be used in conjunction with detection switches to identify a particular card controller 110a, 110b, and 110c to memory package 130. That is, memory card A includes card controller 110a and the first designation pattern 140a, memory card B includes card controller 110b and the second designation pattern 140b, and memory card C includes the card controller 110c and the third designation pattern 140c.

The respective designation patterns 140a, 140b, or 140c are physically disposed within respective adaptors 150 to mate with one of the plurality of recognition patterns 142a, 142c, or 142c disposed on memory package 130. In the illustrated example, similarly shaped recognition patterns 140 and designation patterns 142 are used. However, different shaped patterns might also be used. Regardless of the shape or physical disposition, the unique plurality of designation patterns 140 identifies the nature of a corresponding card controller, protocol, etc., to the common memory package 130. In this manner, a single type of generic memory package may be used in conjunction with different types of memory cards, where such difference is largely defined by the nature and operation of a corresponding card controller. This operative flexibility may be used in relation to any type of memory card connection (i.e., full insertion recess, partial insertion recess, or connection contacts).

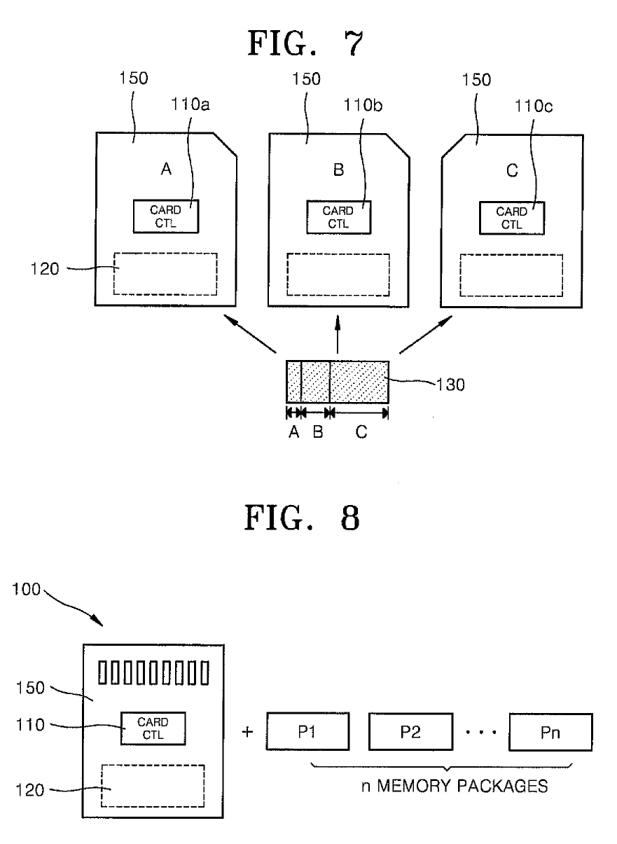

Referring to FIG. 7, a commonly useable memory package 130 includes a recognition program called by a constituent card controller upon connection with a memory card 100. By operation of this recognition program, memory package 130 is able to identify different kinds of memory cards, (e.g., memory cards A, B, and C), as characterized by different card controllers 110a, 110b, and 110c. The memory space provided by memory package 130 is partitioned to provide this capability. That is, a first memory region A of memory package 130 is used to store the recognition program. The recognition program may be conventionally implemented to identify the type or operating nature of card controllers 110a, 110b, or 110c respectively included in adaptor 150 of memory cards A, B, and C, and may be set to run upon connection of memory 130 to a memory card 100 A second memory region B may be used to store drivers, application programming interfaces (APIs), and other software routines enabling the communication of data between memory package 130 and each one of the variously compatible card controllers 110a, 110b, and 110c. A third memory region C is used to store data.

The recognition program stored in memory region A and the driver programs stored in memory region B may be patched, updated or expanded, as needed, upon connection to a card controller.

The memory card 100 of FIG. 8 has the capability of simultaneously connecting multiple memory packages in order to expand its storage capacity. For example between 1 and “n” memory packages may be connected with card controller 110 and mechanically coupled to adaptor 150. Thus, a common card controller 110 may be used in conjunction with memory card of variable data storage capacity. Where a customer requires only 1 GB of memory a single 1 GB memory package 130 is inserted into full insertion recess 120 of adaptor 150. However, where the customer requires 10 GB of memory, ten 1 GB memory packages may be inserted into full insertion recess 120. This example assumes 1 GB memory packages, but any size may serve. The structure of the mechanical/electrical connection (e.g., full insertion recess 120, partial insertion recess 122, or connection contacts 124) may be altered, as needed, to accommodate multiple memory packages 130 into a single memory card 100 to run in relation to a single card controller 110.

While the present invention has been particularly shown and described with reference to exemplary embodiments thereof, it will be understood by those of ordinary skill in the art that various changes in form and details may be made therein without departing from the scope of the present invention as defined by the following claims.

What is claimed is:

1. A memory card comprising:
an adaptor comprising a card controller controlling operations of the memory card; and
a memory package capable of being electrically/mechanically connected to and separated from the adaptor via a connection structure.

2. The memory card of claim 1, wherein the connection structure is a full insertion recess disposed on the adaptor.

3. The memory card of claim 1, wherein the connection structure is a partial insertion recess disposed on the adaptor.

4. The memory card of claim 1, wherein the connection structure is at least one pair of connection contacts disposed respectively on the adaptor and the memory package.

5. The memory card of claim 1, wherein the functionality of the card controller is defined in relation to one of a plurality of memory card types.

6. The memory card of claim 1, wherein the adaptor comprises one of a plurality of designation patterns, wherein each designation pattern indicates one of the plurality of memory card types.

7. The memory card of claim 6, wherein each one of the plurality of designation patterns is disposed at a different position on the adaptor: and
the memory card comprises a plurality of recognition patterns corresponding one for one with the plurality of designation patterns.

8. The memory card of claim 7, wherein the memory package recognizes a memory card type upon connection of the one designation pattern with one of the plurality of recognition patterns.

9. The memory card of claim 1, wherein the memory package comprises a memory including a first memory region storing a recognition program capable upon connection of the memory package to the adaptor of identifying a memory card type for the memory card in relation to the functionality of the card controller.

10. The memory card of claim 9, wherein the memory includes a second region storing driving programs controlling communication of data between the card controller and the memory packages and a third region storing the data.

11. The memory card of claim 10, wherein the recognition program and the driving programs may be updated upon connection of the memory package to the card controller.

12. The memory card of claim 3, wherein the memory package includes a connection protrusion adapted for insertion with the partial insertion recess.

13. The memory card of claim 1, wherein the connection structure comprises a structure disposed on the adaptor which facilitates the simultaneous connection of a plurality of memory packages.

14. A method of using a memory card, the method comprising:
electrically and mechanically connecting an adaptor including a card controller to a memory package via a connection structure;
identifying a memory card type in relation to the functional nature of the card controller upon connection of the memory package with the adaptor; and
communicating data between the card controller and memory package.

15. The method of claim 14, wherein the adaptor comprises one of a plurality of designation patterns, wherein each designation pattern identifies one of a plurality of memory card type; and
the memory card comprises a plurality of recognition patterns corresponding one for one with the plurality of designation patterns.

16. The method of claim 14, wherein the memory package comprises a memory including a first memory region storing a recognition program, and the method further comprises:
upon connection of the memory package to the adaptor identifying the memory card type by operation of the recognition program.

17. The method of claim 16, wherein the memory includes a second region storing driving programs, and a third region for storing data; and
the method further comprises:
following identification of the memory card type, controlling communication of data between the card controller and the memory package by operation of the driving programs; and
storing data in the third region.

18. The memory card of claim 17, wherein the recognition program and the driving programs may be updated upon connection of the memory package to the card controller.
